(19) United States
(12) Patent Application Publication
(10) Pub. No.: US 2024/0034105 A1
(43) Pub. Date: Feb. 1, 2024

(54) TIRE INFLATION SYSTEM

(71) Applicant: DANA ITALIA S.R.L., Arco (IT)

(72) Inventor: Piergiorgio TRINCHIERI, Arco (IT)

(21) Appl. No.: 18/360,642

(22) Filed: Jul. 27, 2023

(30) Foreign Application Priority Data
Jul. 28, 2022 (DE) 20 2022 104 274.8

(51) Int. Cl. B60C 23/00

(52) U.S. Cl. CPC B60C 23/00347

(57) ABSTRACT

The present document relates to a tire inflation system having a non-rotatable element and a rotatable element mounted at the non-rotatable element, a fluid path extending through a cavity of the non-rotatable element and through a cavity of the rotatable element for passing a fluid from the non-rotatable element to the rotatable element. At least one of the rotatable element and the non-rotatable element is movable in an axial direction with respect to the other between a standard position and an inflation position, and is configured to slide towards the inflation position against the bias of a return spring, in response to a fluid pressure being provided in the fluid path. In the inflation position the gasket is in sealing engagement with the contact area.

### CROSS-REFERENCE TO RELATED APPLICATION

The present application claims priority to German Utility Model Application No. 20 2022 104 274.8, entitled “TIRE INFLATION SYSTEM”, and filed Jul. 28, 2022. The entire contents of the above-listed application is hereby incorporated by reference for all purpose.

### TECHNICAL FIELD

The present document relates to the field of mechanical engineering, for example to vehicle technology. More specifically, the present document primarily relates to a tire inflation system which may be used in an off-highway vehicle, for example.

### BACKGROUND AND SUMMARY

Known tire inflation systems allow a tire to be inflated or deflated during operation of the vehicle such as when the vehicle is traveling. For example, a fluid such as air may be passed from a non-rotatable part to a rotatable part in order to inflate a tire mounted on the rotatable part, or vice versa. Consequently, a seal between the rotatable part and the non-rotatable part must be established to allow fluid to be transferred between the non-rotatable part and the rotatable part, but excess friction between the parts should be avoided.

In view thereof, it is an object of the present disclosure to propose a tire inflation system in which sealing between the rotatable part and the non-rotatable part may be controlled with high accuracy, and in friction between rotating components is reduced. Special embodiments are described in the dependent claims and in the following description and the figures.

Accordingly, the presently proposed a tire inflation system comprises a non-rotatable element and a rotatable element mounted on or at the non-rotatable element. A fluid path extends through a cavity of the non-rotatable element and through a cavity of the rotatable element, for passing a fluid such as air from the non-rotatable element to the rotatable element. At least one of the rotatable element and the non-rotatable element is movable in an axial direction with respect to the other, between a standard position and an inflation position, and is configured to slide towards the inflation position, against the bias of a return spring, in response to a fluid pressure being provided in the fluid path. A gap is formed or provided between the non-rotatable element and the rotatable element. One of the non-rotatable element and the rotatable element holds a gasket that extends within the gap, and a remaining one of the non-rotatable element and the rotatable element defines a contact area for the gasket. In the inflation position, the gasket is in sealing engagement with the contact area.

For example, this solution provides very well-controlled sealing as the gasket is brought in engagement with the contact area.

The fluid path extends through a cavity of the non-rotatable element and through a cavity of the rotatable element, for passing a fluid such as air from the non-rotatable element to the rotatable element. The rotatable element may hold a tire that can be inflated by the fluid. The rotatable element may also be connected to a rotatable flange or the like, which holds the tire that can be inflated by the fluid. Deflation of the tire via the same fluid path, or via a further fluid path including the same features or different features, may also be envisioned. At least one of the rotatable element and the non-rotatable element is movable in an axial direction with respect to the other, between a standard position and an inflation position. for example, the rotatable element may be configured to move axially to the inflation position, wherein the return spring biases the rotatable element towards the standard position. Additionally or alternatively, the non-rotatable element may be configured to move axially to the inflation position, wherein the return spring, or a second return spring, biases the non-rotatable element to the standard position. In a possible embodiment, the rotatable element is movable in the axial direction, wherein the non-rotatable element is fixed in the axial direction.

At least a section of the non-rotatable element may extend within or may be received within the rotatable element, or vice versa. For instance, the rotatable element may extend axially distally of the non-rotatable element, wherein an axial overlap may be provided between the rotatable element and the non-rotatable element.

For example, in response to the fluid pressure being provided in the fluid path, the rotatable element may be configured to move in an axially distal direction from the standard position towards the inflation position.

For example, in response to the fluid pressure being provided in the fluid path, as the elements assume the inflation position, the gasket may assume an axially aligned position with the contact area. Specifically, the gasket and the contact area may be axially offset from each other in the standard position and they may be configured to align axially in the inflation position. The system may be transfereed between the standard position and the inflation position by a relative axial movement between the rotatable and the non-rotatable element. For example, the rotatable element may be configured to move in an axial direction, such as an axial distal direction, in response to the fluid pressure being provided in the fluid path, thereby axially aligning the gasket with the contact area.

In an embodiment, a rotatable flange may be provided and connected to the rotatable element. The rotatable flange may be configured to rotate along with the rotatable element. For instance, the rotatable flange may hold the tire. For example, the rotatable element may be movably arranged at or within the flange to allow the rotatable element to move in the axial direction with respect to the non-rotatable element and/or with respect to the flange. For example, the return spring may be provided between the rotatable element and the flange.

In one mode of operatio of the tire inflation system, the vehicle and the wheel may be stationary and the rotatable element may not be rotating. The gasket may be sealingly engaged with the contact area by axially moving the rotatable element and/or the non-rotatable element, for example to inflate the tire. In a another mode of operation of the tire inflation system, the vehicle may be in motion and the rotatable element may rotate, along with the wheel. In this case, the gasket may be sealingly engaged with the contact area by axially moving the rotatable element and/or the non-rotatable element.

The gap formed or provided between the non-rotatable element and the rotatable element and in which the gasket extends may be a radial or radially extending gap. In this case, the gap may be seen as forming an annular gap-chamber arranged between an inner element of the rotatable element and the non-rotatable element, and an outer element of the rotatable element and the non-rotatable element. At least a section of the inner element may extend within the outer element. The gasket may protrude from the element on which it is mounted, for examle towards the other element in a radial direction. For example, the gasket may be provided at or may be mounted on the rotatable element forming an outer element or outer shaft, and may protrude inwards from an inner diameter of the outer rotatable element and towards the inner non-rotatable element. In other embodiments, the gasket may be provided at or mounted on the inner element and may protrude radially outward and/or the rotatable element may form the inner element.

In an embodiment, the gasket may be provided or mounted on the rotatable element, and the contact area may be formed or provided on the non-rotatable element. In an embodiment, the gasket is provided on the non-rotatable element and the contact area is formed or provided on the rotatable element. It may also be envisioned that more than one gasket is present in the system, the more than one gaskets being provided on either one or on both of the elements. In an example, a first gasket is disposed or provided on an axially inner side of the chamber, and a second gasket is disposed or provided on an axially outer side of the chamber.

The contact area may be formed or provided on a protrusion protruding from the respective element which defines the contact area. The protrusion may for instance be arranged to axially align with the gasket in the inflation position. For example, the protrusion may be provided on an inner element of the non-rotatable element and the rotatable element, by way of an increased outer diameter of the inner element. For example, the increased diameter may be provided at an end portion of the inner element. For example, the protrusion may be provided on an outer element of the non-rotatable element and the rotatable element, for instance by way of a decreased inner diameter of the outer element.

The protrusion may for example include widening section, for example in the form of a conical section. By way of example, in response to the fluid pressure being provided in the fluid path, the gasket may be configured to slide across the widening or conical section, to the contact area, during transition from the standard position towards the inflation position. Finally, in the inflation position, the gasket and the contact area are axially aligned, as explained above. As the pressure ceases, the gasket moves back across the widening or conical section, and to a position that is axially offset from the contact area. This allows smooth transition between the two positions.

For example, the gasket may be made of a compressible material. For example, the gasket may comprise rubber, such as a rigid rubber or a flexible rubber.

For example, the sealing engagement between the gasket and the contact area may include the gasket being compressed. As the gasket moves back away from the contact area, it may expand again.

The non-rotatable element may for instance be a radially inner element, such as an inner shaft, and the rotatable element may be a radially outer element, such as an outer shaft, wherein the radially outer rotatable element at least sectionally surrounds the non-rotatable element.

The rotatable element may for instance be a radially inner element, such as an inner shaft, and the non-rotatable element may for instance be a radially outer element, such as an outer shaft, the non-rotatable element at least sectionally surrounding the rotatable element.

For example, a chamber may be provided in the fluid path. The chamber may be arranged between the cavity of the non-rotatable element and the cavity of the rotatable element. In an example, at least a portion of the chamber is provided at an axial position that is between the cavity of the non-rotatable element and the cavity of the rotatable element, wherein the fluid may flow with a directional component in an axially distal direction, from the cavity of the non-rotatable element, to the chamber, and to the cavity of the rotatable element. The chamber may be sectionally delimited by a pressure surface that is provided on the at least one element that is movable in the axial direction. Said axially movable element may be configured to move to the inflation position in response to a fluid pressure in the chamber and against the pressure surface.

The rotatable element and the non-rotatable element may be displaceable with respect to each other by at least 2 mm or at least 3 mm and/or by at most 10 mm or at most 8 mm or at most 7 mm in the axial direction, between the standard position and the inflation position. This may be the case for when a movement of both elements is envisioned, or for when a movement of only one of the elements is envisioned.

The presently proposed tire inflation system will now be exemplarily be explained with reference to the appended figures, wherein

### BRIEF DESCRIPTION OF THE FIGURES

FIGS. 1A-1B show a first embodiment of the tire inflation system in a standard position and in an inflation position.

FIGS. 2A-2D show different views of a detailed exemplary embodiment of the tire inflation system in a tractor hub.

### DETAILED DESCRIPTION

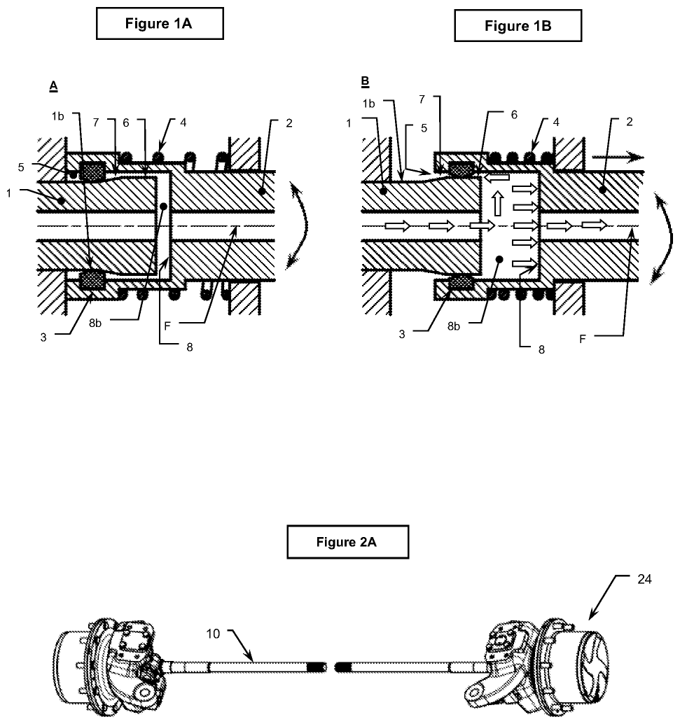

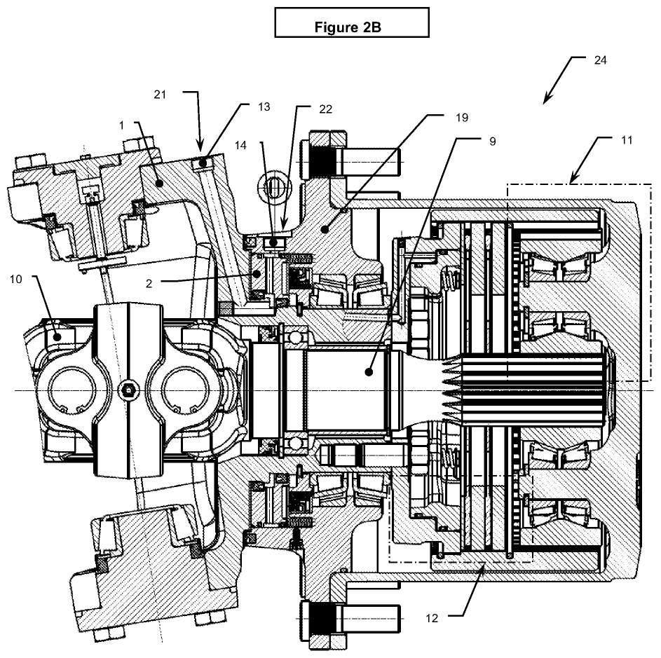

FIGS. 1A and 1B show a tire inflation system having a non-rotatable element 1 forming an inner fixed shaft, and a rotatable element 2 mounted on or at the non-rotatable element 1. The rotatable element 2 forms an outer shaft. A section of the rotatable element 2 surrounds the non-rotatable element 1. The tire inflation system is designed as an automatic central tire inflation system which may be used in an off-highway vehicle, for example, and which enables inflation and deflation of the tire both when the vehicle is traveling and when the vehicle stops. When the vehicle is in motion, the rotatable element 2 rotates as indicated by the double-arrow on the right-hand side of FIGS. 1A and 1B.

FIG. 1A shows the system in a standard position A in which a degree of friction between a gasket 3 mounted on the rotatable element 2 and the non-rotatable element 1 is low. And FIG. 1B shows the system of FIG. 1A in an inflation position B in which a fluid path for inflating the tire is sealed.

Referring to both FIGS. 1A and 1B, a fluid path F extends through a cavity of the non-rotatable element 1 and through a cavity of the rotatable element 2, for passing a fluid such as air from the non-rotatable element 1 to the rotatable element 2. Along a rotation axis of the rotatable element 2, the rotatable element 2 extends distally of the non-rotatable element 1. The rotatable element 2 surrounds the non-rotatable element 1 at least in section along the axial direction. The rotatable element 2 is movable relative to the non-rotatable element 1 in the axial direction, between the standard position A and the inflation position B.

The rotatable element 2 is thereby configured to slide in an axially distal direction from the standard position A and towards the inflation position B, i. e. to the right, as indicated by an arrow in FIG. 1B, for example against the bias of a return spring 4. Sliding of the rotatable element 2 occurs in response to a fluid pressure being provided or applied in the fluid path. The fluid pressure and fluid flow are indicated in FIG. 1B by way of arrows in the fluid path F. Therein, a chamber 8b is provided in the fluid path, between the cavity of the non-rotatable element 1 and the cavity of the rotatable element 2, the chamber 8b being sectionally delimited, on its right side, by a pressure surface 8 provided or formed on the rotatable element 2. The rotatable element 2 is thus configured to move to the inflation position B in response to the fluid pressure in the chamber 8b and against the pressure surface 8. Therein, the rotatable element 2 and the non-rotatable element 1 are displaceable with relative to one another in the axial direction between the standard position A and the inflation position B, for example by between 3 mm and 7 mm.

A radially extending annular gap 5 is formed or provided between the non-rotatable element 1 and the rotatable element 2. The non-rotatable element 1 forms an inner shaft and the rotatable element 2 forms an outer shaft, the radial gap 5 forming an annular hollow space between them, the radial gap 5 surrounding the inner non-rotatable shaft 1.

The gasket 3 mounted on the rotatable element 2 is compressible. For example, the gasket 3 may include or may be made of rigid rubber. In the embodiment depicted in FIGS. 1A and 1B, the gasket is received in an indentation formed in an inward facing surface of the rotatable element 2. It us understood that in alternative embodiments the gasket 3 may be mounted on or fixed to the rotatable element 2 in other ways, such by means of connecting elements such as screws or bolts, for example. The gasket 3 extends within the gap 5. The non-rotatable element 1 defines a contact area for the gasket 3. In the inflation position B shown in FIG. 1B, the gasket 3 is axially aligned and in sealing engagement with the contact area formed on the outer surface of the non-rotatable element 1.

The contact area is provided or formed on a protrusion or increased diameter portion 6 protruding from the non-rotatable element 1. Here, the protrusion 6 is provided by way of an increased outer diameter of the inner non-rotatable shaft, for example at an end portion thereof. The protrusion 6 is arranged to axially align with the gasket 3 in the inflation position B. Therein, the protrusion 6 includes a conical section 7 where the diameter of the inner non-rotatable shaft widens. In response to the fluid pressure being provided in the fluid path, the gasket 3 is configured to slide across the conical section 7 to the contact area when transitioning from the standard position A towards the inflation position B. The sealing engagement between the gasket 3 and the contact area includes the gasket 3 being compressed, e.g. the gasket experiences compression as it slides along the conical section 7 and when it is located at the protrusion 6.

When the fluid pressure is released, the return spring 4 pushes the rotatable element back into the standard position A where the gasket 3 is axially aligned with an annular surface 1b formed on a decreased diameter portion of the inner non-rotatable shaft, and axially offset from the contact area. Specifically, along the rotation axis of the rotatable element 2 the annular surface 1b of the non-rotatable element 1 is disposed at a distance from an end portion of the non-rotatable element 1 facing the rotatable element 2 and including the increased diameter portion or protrusion 6. When the system is in the standard position A and the circuit is not under pressure, the gasket 3 may provide a well-defined seal between the outer rotating or rotatable element 2 and the annular surface 1b of the non-rotatable element 1, with very low and well-defined compression and with a low degree of friction between the gasket 3 and the annular surface 1b of the non-rotatable element 1.

As can be seen from FIGS. 1A and 1B, the solution presented here shows well-defined compression of the gaskets which depends on or is controllable via the diameters provided on the non-rotatable element 1. Consequently, sealing and friction are geometrically controlled in the two states (standard position A and inflation position B). This is in contrast to known solutions where the sealing contact may depend directly on the inflation pressure, for instance.

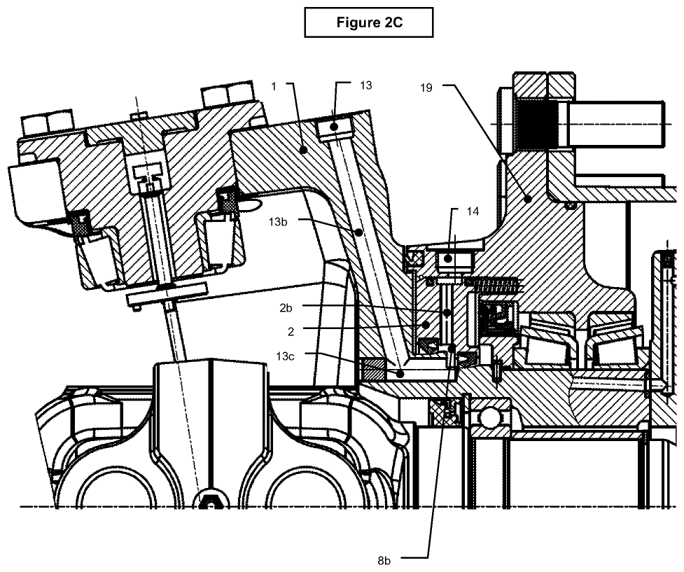

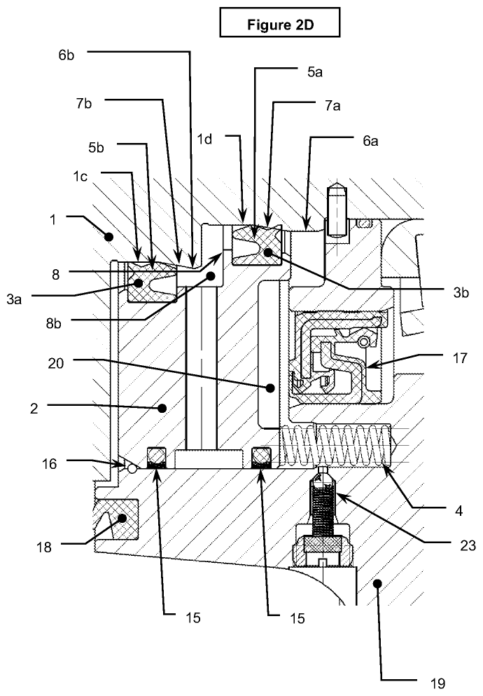

FIGS. 2A-2D show various views of a tire inflation system.

FIG. 2A shows an overview of a drive shaft 10 with tractor hubs 24 in which the system is provided. FIGS. 2B, 2C, and 2D show cut views, exposing further details of the tractor hub 24. A planetary reduction gear 11 is driven by a splined shaft 9 connected to the drive shaft 10. A hydraulic brake 12 is provided in the system.

The hub 24 is supported by a non-rotatable element 1 forming an inner shaft. The non-rotatable element 1 is fixed while a rotatable element 2, which is connected to a flange 19, rotates with the tire rim. The rotatable element 2 is rotatably mounted on or at the non-rotatable element 1. A section of the rotatable element 2 surrounds the non-rotatable element 1.

FIG. 2D shows a standard position in which no inflation takes place. When tire inflation is initiated, air coming from a compressor streams through air inlet 21. This inlet 21 is connected to a threaded port 13 while an air outlet 22 is connected to a second threaded port 14 so that the air can stream towards the tire. Therein, a fluid path extends through a cavity of the non-rotatable element 1 and through a cavity of the rotatable element 2, for passing a fluid from the non-rotatable element 1 to the rotatable element 2 and finally to the tire.

As can best be seen from FIGS. 2C and 2D, the pressurized air supplies port 13, and passes through holes 13b and 13c, and then enters chamber 8b of the rotatable element 2. A series of radial holes 2b are provided for air outlet from the chamber 8b towards the second threaded port 14.

The rotatable element 2 holds two compressible gaskets 3a, 3b made of rubber. The gaskets 3a, 3b are located within radial gaps 5a, 5b provided between the non-rotatable element 1 and the rotatable element 2. In the status shown in FIG. 2D, which is the standard position in which no inflation takes place, the gaskets 3a, 3b are axially aligned with annular surfaces 1c, 1d provided on the non-rotatable element 1, providing a well-defined comparably low seal with low friction.

The chamber 8b is provided in the fluid path, between the cavity of the non-rotatable element 1 and the cavity of the rotatable element 2, and it is on one side delimited by a pressure surface 8 provided on the rotatable element. The pressure surface 8 thereby forms an annular thrust area at the rotatable element 2. A normal vector of the annular thrust area is along the axial direction. The rotatable element 2 is thus configured to move in an axial distal direction (to the right) with respect to the non-rotatable element 1, to an inflation position, in response to a fluid pressure acting in the chamber 8b and against the pressure surface 8. A return spring 4 is provided for biasing the rotatable element 2 to the left, to the standard position, the spring being supported on the flange 19. An elastic ring 16 provided on the flange 19 defines the end stroke to the left, in turn defining the standard position. Two static seals 15 are provided, allowing axial movement of the rotatable element 2 with respect to the rotatable flange 19. A dust seal 18 provided between the rotatable flange 19 and the non-rotatable element 1 protects the internal mechanism of the rotatable element 2 from external contamination.

This setup allows for an axial displacement between the rotatable element 2 and the non-rotatable element of approximately 5 mm in the axial direction, between the standard position and the inflation position.

As pressure is applied to chamber 8b, this pressure pushes on the annular pressure surface 8 of the rotatable element 2, overcoming the return spring 4, and moving the rotatable element 2 to the right by the above-mentioned amount of approximately 5 mm. Thereby, the gaskets 3a, 3b pass from the low-friction low-sealing engagement with the small diameters 1c, 1d past the conical sections 7a, 7b and to the large diameter protrusions 6a, 6b. The large diameter protrusions 6a, 6b form contact areas for the gaskets 3a, 3b. The gaskets 3a, 3b axially align with these contact areas in the inflation position. This results in compression of the gaskets 3a, 3b, as the protrusions protrude towards the rotatable element 2 which holds the gaskets 3a, 3b. The compression amount is well-defined by the geometry of the non-rotatable element 1 and the protrusions 6a, 6b formed thereon. The compressed seals 3a, 3b form a tight seal between the rotatable element 2 and the non-rotatable element 1, allowing to inflate the tire through the fluid path.

This tight seal is only maintained during inflation. When the inflation phase ceases, the pressure in the hub goes to zero and the rotatable element 2, by way of the return spring 4, returns to its initial standard position, towards the left, onto the end stroke ring 16, relieving the compression of the set of the dynamic gaskets 3a, 3b, once again reducing friction and thus avoiding excess wear of the gaskets 3a, 3b.

A unidirectional air vent valve 23 is provided in the flange 19, as shown in FIG. 2D, to allow the pressure of a further chamber 20 to escape as the rotatable element 2 moves from the standard position to the inflation position. This helps to avoid lifting the sealing arrangement 17, which might otherwise cause oil leaks.

In another example, a method is disclosed for operating a tire inflation system as disclosed here, including a system having a non-rotatable element and a rotatable element mounted at the non-rotatable element, and a fluid path extending through a cavity of the non-rotatable element and through a cavity of the rotatable element. The method may include passing a fluid from the non-rotatable element to the rotatable element; and moving at least one of the rotatable element and the non-rotatable element in an axial direction with respect to the other, between a standard position and an inflation position. The method may further include sliding the element towards the inflation position, against the bias of a return spring, in response to a fluid pressure being provided in the fluid path, where a gap is provided between the non-rotatable element and the rotatable element. One of the non-rotatable element and the rotatable element may hold a gasket that extends within the gap, a remaining one of the non-rotatable element and the rotatable element defining a contact area for the gasket. The method may further include, during the inflation position, keeping the gasket in sealing engagement with the contact area. Each of the figures is drawn to scale, although other relative dimensions may be used, if desired. Further, the fitgures show example configurations with relative positioning of the various components. If shown directly contacting each other, or directly coupled, then such elements may be referred to as directly contacting or directly coupled, respectively, at least in one example. Similarly, elements shown contiguous or adjacent to one another may be contiguous or adjacent to each other, respectively, at least in one example. As an example, components laying in face-sharing contact with each other may be referred to as in face-sharing contact. As another example, elements positioned apart from each other with only a space there-between and no other components may be referred to as such, in at least one example. As yet another example, elements shown above/below one another, at opposite sides to one another, or to the left/right of one another may be referred to as such, relative to one another. Further, as shown in the figures, a topmost element or point of element may be referred to as a “top” of the component and a bottommost element or point of the element may be referred to as a “bottom” of the component, in at least one example. As used herein, top/bottom, upper/lower, above/below, may be relative to a vertical axis of the figures and used to describe positioning of elements of the figures relative to one another. As such, elements shown above other elements are positioned vertically above the other elements, in one example. As yet another example, shapes of the elements depicted within the figures may be referred to as having those shapes (e.g., such as being circular, straight, planar, curved, rounded, chamfered, angled, or the like). Further, elements shown intersecting one another may be referred to as intersecting elements or intersecting one another, in at least one example. Further still, an element shown within another element or shown outside of another element may be referred as such, in one example

1. A tire inflation system having a non-rotatable element and a rotatable element mounted at the non-rotatable element,
a fluid path extending through a cavity of the non-rotatable element and through a cavity of the rotatable element, for passing a fluid from the non-rotatable element to the rotatable element,
wherein at least one of the rotatable element and the non-rotatable element is movable in an axial direction with respect to the other, between a standard position and an inflation position, and is configured to slide towards the inflation position, against the bias of a return spring, in response to a fluid pressure being provided in the fluid path,
wherein a gap is provided between the non-rotatable element and the rotatable element,
one of the non-rotatable element and the rotatable element holding a gasket that extends within the gap, and a remaining one of the non-rotatable element and the rotatable element defining a contact area for the gasket,
wherein, in the inflation position, the gasket is in sealing engagement with the contact area.

2. The tire inflation system of claim 1, wherein the rotatable element is movable in the axial direction.

3. The tire inflation system of claim 1, wherein the rotatable element is configured to move in an axial direction in response to the fluid pressure being provided in the fluid path, from the standard position towards the inflation position, to axially align the gasket with the contact area.

4. The tire inflation system of claim 1, wherein the gap is a radial gap.

5. The tire inflation system of claim 1, wherein the gasket is provided on the rotatable element and the contact area is provided on the non-rotatable element, or wherein the gasket is provided on the non-rotatable element and the contact area is provided on the rotatable element.

6. The tire inflation system of claim 1, wherein the contact area is provided on a protrusion protruding from the respective element which defines the contact area, the protrusion being arranged to axially align with the gasket in the inflation position.

7. The tire inflation system of claim 6, wherein the protrusion is provided on a radially inner element of the non-rotatable element and the rotatable element by way of an increased outer diameter of the inner element, for example at an end portion thereof.

8. The tire inflation system of claim 6, wherein the protrusion is provided on a radially outer element of the non-rotatable element and the rotatable element by way of a decreased inner diameter of the outer element.

9. The tire inflation system of claim 6, wherein the protrusion includes a widening section, such as a conical section, wherein, in response to the fluid pressure being provided in the fluid path, the gasket is configured to slide across the widening section to the contact area during transition from the standard position towards the inflation position.

10. The tire inflation system of claim 1, wherein the sealing engagement between the gasket and the contact area includes the gasket being compressed.

11. The tire inflation system of claim 1, wherein the non-rotatable element forms a radially inner element, in particular an inner shaft, and the rotatable element forms a radially outer element, in particular an outer shaft, the rotatable element at least sectionally surrounding the non-rotatable element, or wherein the rotatable element forms a radially inner element, in particular an inner shaft, and the non-rotatable element forms a radially outer element, in particular an outer shaft, the non-rotatable element at least sectionally surrounding the rotatable element.

12. The tire inflation system of claim 1, wherein a chamber is provided in the fluid path, between the cavity of the non-rotatable element and the cavity of the rotatable element, the chamber being sectionally delimited by a pressure surface provided on the at least one element that is movable in the axial direction, said element being configured to move to the inflation position in response to a fluid pressure in the chamber and against the pressure surface.

13. The tire inflation system of claim 1, wherein the rotatable element and the non-rotatable element are displaceable with respect to each other by at least 2 mm in the axial direction, between the standard position and the inflation position.

14. The tire inflation system of claim 1, wherein the rotatable element and the non-rotatable element are displaceable with respect to each other by at least 3 mm in the axial direction, between the standard position and the inflation position.

15. The tire inflation system of claim 1, wherein the rotatable element and the non-rotatable element are displaceable with respect to each other by at most 10 mm in the axial direction, between the standard position and the inflation position.

16. The tire inflation system of claim 1, wherein the rotatable element and the non-rotatable element are displaceable with respect to each other by at most 7 mm in the axial direction, between the standard position and the inflation position.
